(19) United States
(12) Patent Application Publication
(10) Pub. No.: US 2012/0319977 A1
(43) Pub. Date: Dec. 20, 2012

(54) DISPLAY DEVICE WITH TOUCH PANEL, CONTROL METHOD THEREFOR, CONTROL PROGRAM, AND RECORDING MEDIUM

(75) Inventor: Yoichi Kuge, Osaka (JP)

(73) Assignee: SHARP KABUSHIKI KAISHA, Osaka (JP)

(21) Appl. No.: 13/578,723

(22) PCT Filed: Nov. 24, 2010
(86) PCT No.: PCT/JP2010/070923

§ 371 Date: Aug. 13, 2012

(30) Foreign Application Priority Data
Feb. 16, 2010 (JP) 2010-031635

(51) Int. Cl. G06F 3/041

(52) U.S. Cl. 345/173

(57) ABSTRACT

Provided is a display device equipped with a touch panel that can be operated with ease and with a high accuracy. The display device equipped with a touch panel of the present invention includes a touch panel and a display panel. The touch panel includes a touch input section, a finger location detecting section, a fingertip orientation detecting section, and an information output section. The touch input section receives a touch operation performed by a plurality of fingers of a user. The finger location detecting section detects the locations of the fingers used to perform the touch operation. The fingertip orientation detecting section detects the fingertip orientations of the fingers used to perform the touch operation. The information output section outputs information on finger location detected by the finger location detecting section, and on the fingertip orientation detected by the fingertip orientation detecting section.

### TECHNICAL FIELD

The present invention relates to a display device equipped with a touch panel, to a method for controlling the same, and also to a control program and a recording medium for the same. More particularly, the present invention relates to a display device equipped with a touch panel that can easily and accurately be operated, to a method of controlling the same, and also to a control program and a recording medium for operating the same.

### BACKGROUND ART

Conventionally, display devices that can display sub-images such as on-screen menus over the main image have been known. Such display devices, when combined with a touch panel, can be configured as input operation type display devices (display devices equipped with a touch panel).

Normally, images displayed on the input operation type display device can be shifted by touching the image with a finger, and then moving the finger in a desired direction.

The touch panel of the input operation type display device normally has a function for removing operation errors caused by touch operations performed at two locations within a prescribed time period.

A known example of the technology for removing the operation error of the touch panel does not just determine the coordinates (location) of a touch on a resistive touch panel based on the resistance voltage division ratio, but also distinguishes a one-point touch from a two-point touch based on the current that flows as a result of the touch operation.

Another known technology aims at using the two-point touch operation on the touch panel to change a variety of image display styles (see Patent Document 1, for example).

Specifically, as shown in FIG. 11, a display device 200 disclosed in Patent Document 1 employs: a display that can display a plurality of images (image display unit 120); a touch panel that is disposed on the front surface of the display and can output information indicating the nature of the touch operation performed at two points within a specified period of time (touch panel unit 110); a line segment calculation section 101 that calculates the coordinates of the two points associated with the touch operation and the direction and length of the line segment defined by the two points based on the information output value of the touch panel; and a display change section 102 that changes the image display style on the display based on the calculation result of the line segment calculation section 101.

Further, the display device 200 disclosed in Patent Document 1 is controlled as shown in the flowchart in FIG. 12, which describes a display control method performed during the navigation independent mode by a control unit 100 (the line segment calculation section 101 and the display change section 102) shown in FIG. 11.

According to the flowchart shown in FIG. 12, in step S113, the control unit 100 determines whether the calculated length of the line segment is valid or not with reference to a predetermined threshold or in a similar manner. This determination process is designed to avoid the operation error that can be caused by an accidental two-point touch by two fingers for an operation intended to be performed by a one-point touch. Therefore, if the calculated length of the line segment is extremely short and is determined to be invalid in step S113 (step S113: N), the control unit 100 terminates this process in the navigation independent mode in the display control method. On the other hand, if the calculated length of the line segment is determined to be valid in step S113 (step S113: Y), the control unit 100 determines whether the direction of the line segment is oblique or not in step S114. If the direction of the line segment is determined to be oblique (step S114: oblique), the control unit 100 further determines whether the line segment is long or short with reference to a predetermined threshold or in a similar manner in step S115. If the length of the line segment is determined to be long in step S115 (step S115: large), in step S116, the display change section 102 of the control unit 100 displays a zoomed-out image of the map shown on the display of the image display unit 120 with a scale according to the length of the segment, and ends this process in the navigation independent mode in the display control method. On the other hand, if the line segment is determined to be short in step S115 (step S115: small), in step S117, the display change section 102 displays a zoomed-in image of the map shown on the display with a scale according to the length of the line segment, and ends this process in the display control method.

If the direction of the line segment is determined to be vertical or horizontal in step S114, (step S114: vertical/horizontal), in step S118, the control unit 100 determines whether an on-screen menu for defining individual regions for a plurality of soft keys 132 is being shown on the display of the image display unit 120 or not. If the on-screen menu is being displayed (step S118: Y), the control unit 100 further determines in step S119 whether the coordinates of the two points calculated by the line segment calculation section 101 are both located on the on-screen menu. Based on the result, the control unit 100 determines whether the two-point touch operation on the touch panel 111 has been performed on the on-screen menu or not. If the two-point touch operation on the touch panel 111 is determined to have been performed on the on-screen menu in step S119 (step S119: Y), the display change section 102 of the control unit 100 displays another on-screen menu defined as shortcuts of the above-mentioned on-screen menu in step S120, and ends this process in the display control method in the navigation independent mode. On the other hand, if, in step S119, the two-point touch operation is determined not to have been performed on the on-screen menu (step S119: N), the display change section 102 displays a vertical on-screen menu, which is different from the previous horizontal on-screen menu, on the display shown in step S121, and ends this process in the display control method. If the on-screen menu is determined not being displayed in step S118 (step S118: N), the display change section 102 also displays the vertical or horizontal on-screen menu in step S121.

### RELATED ART DOCUMENTS

### Patent Documents

Patent Document 1: Japanese Patent Application Laid-Open Publication No. 2007-241410 (published on Sep. 20, 2007)

### SUMMARY OF THE INVENTION

### Problems to be Solved by the Invention

However, in the conventional display device equipped with a touch panel described above, a finger must be moved to shift a displayed image, because a desired image is displayed based on how the coordinates (location) of a touch change over time.

Also, when two points are touched, the display device equipped with a touch panel disclosed in Patent Document 1 above controls the displayed image based on the coordinates and the slope and length of the line connecting the two points. Therefore, an unintentional touch on the second point after the first point is touched can cause an operation error.

The present invention was devised in consideration of the problems with conventional technology described above, and is aiming at providing a display device equipped with a touch panel that allows the displayed image to be shifted without moving a finger and is not likely to cause operation error, i.e., the display device allowing easy and accurate operation, and a control method for such a display device.

### Means for Solving the Problems

In order to solve the problems described above, a display device equipped with a touch panel of the present invention includes a touch panel that accepts a touch operation by a plurality of fingers of a user and outputs information indicating the nature of the touch operation, and a display panel that displays images based on the above-mentioned information, wherein the above-mentioned touch panel includes a touch input section, a finger location detecting section, a fingertip orientation detecting section, and an information output section, and wherein the touch input section receives a touch operation performed by fingers of a user, the finger location detecting section detects the locations of the fingers used to perform the touch operation, the fingertip orientation detecting section detects the fingertip orientations of the fingers used to perform the touch operation, and the information output section outputs information on the locations of the fingers detected by the finger location detecting section and the fingertip orientation detected by the fingertip orientation detecting section.

According to the configuration described above, because the locations of the fingers can be detected by the finger location detecting section, the starting point of the operation can be determined. Further, because the orientation of the fingertip can be detected by the fingertip orientation detecting section, the direction of the operation can be determined. Thus, a displayed image can be modified based on the starting point of the operation and the direction of the operation.

As a result, a display device equipped with a touch panel according to the present invention does not require a user to move his/her finger to shift a displayed image and also it does not easily cause operation errors. Consequently, the display device can easily and accurately be operated.

In order to solve the problems described above, a method for controlling a display device equipped with a touch panel of the present invention includes: a touch input step of receiving a touch operation performed by a user using a plurality of fingers; a finger location detection step of detecting the locations of fingers used to perform the above-mentioned touch operation; a fingertip orientation detection step of detecting fingertip orientations of the fingers used to perform the above-mentioned touch operation; an information output step of outputting information on the finger locations detected in the finger location detection step and the fingertip orientations detected in the fingertip orientation detection step; and an image display step of displaying images based on the information outputted in the information output step.

According to the configuration described above, the starting point of operation can be determined, because a finger location can be determined in the finger location detection step. Further, direction of operation can be determined, because the fingertip orientation can be detected by the fingertip orientation detection step. Consequently, a display image can be modified based on the starting point of the operation and the direction of the operation.

As a result, in a method for controlling the display device equipped with a touch panel of the present invention, a user does not have to move his/her finger to shift a displayed image, and operation errors are not likely to occur. Therefore, an easy and accurate control of the display device becomes possible.

### Effects of the Invention

As described above, a display devise equipped with a touch panel of the present invention includes a touch panel that receives a touch operation by a plurality of fingers of a user, and outputs information indicating the nature of the touch operation; and a display panel that displays images based on the above-mentioned information, wherein the touch panel includes a touch input section, a finger location detecting section, a fingertip orientation detecting section, and an information output section, and wherein the touch input section receives a touch operation performed by fingers of a user, the finger location detecting section detects locations of the fingers used to perform the touch operation, the fingertip orientation detecting section detects fingertip orientations of the fingers used to perform the touch operation, and the information output section outputs information on the locations of the fingers detected by the finger location detecting section and on the fingertip orientation detected by the fingertip orientation detecting section.

As a result, a display device equipped with a touch panel of the present invention can be operated easily and accurately.

As described above, a method for controlling the display device equipped with a touch panel of the present invention includes: a touch input step of receiving a touch operation performed by a user using a plurality of fingers; a finger location detection step of detecting the location of the fingers used to perform the above-mentioned touch operation; a fingertip orientation detection step of detecting fingertip orientations of the fingers used to perform the above-mentioned touch operation; an information output step of outputting information on the finger location detected in the finger location detection step and on the fingertip orientation detected in the fingertip orientation detection step; and an image display step of displaying images based on the information outputted in the information output step.

Therefore, in the method of controlling the display device equipped with a touch panel of the present invention, an easy and accurate control becomes possible.

### BRIEF DESCRIPTION OF THE DRAWINGS

FIG. 1 is a block diagram showing functions of a display device equipped with a touch panel of the present invention.

FIG. 2 illustrates a touch panel of the present invention when a touch operation by a finger of a user is received.

FIG. 3 schematically shows a circuit configuration of a display panel of the present invention.

FIG. 4 schematically shows the arrangement of optical sensors of a display panel of the present invention.

FIG. 5 is a timing chart showing the voltage applications to a display device equipped with a touch panel of the present invention.

FIG. 6 is a cross-sectional view schematically showing the configuration of a display panel of the present invention.

FIG. 7 is a flowchart showing an example processing of the touch location detection in a display device equipped with a touch panel of the present invention.

FIG. 8 schematically shows locations touched on a display device equipped with a touch panel of the present invention.

FIG. 9 illustrates images displayed on a display device equipped with a touch panel of the present invention. FIG. 9(a) shows the displayed image before the touch and FIG. 9(b) shows the displayed image after the touch.

FIG. 10 is an image displayed on a display device equipped with a touch panel of the present invention.

FIG. 11 is a block diagram showing the functions of a conventional display device equipped with a touch panel.

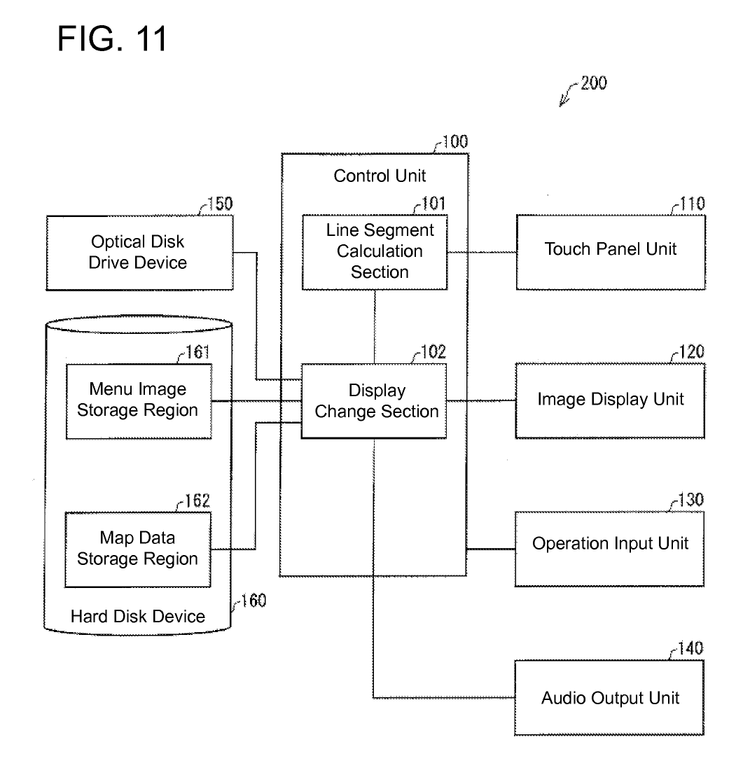

FIG. 12 is a flowchart showing a method for controlling a conventional display device equipped with a touch panel.

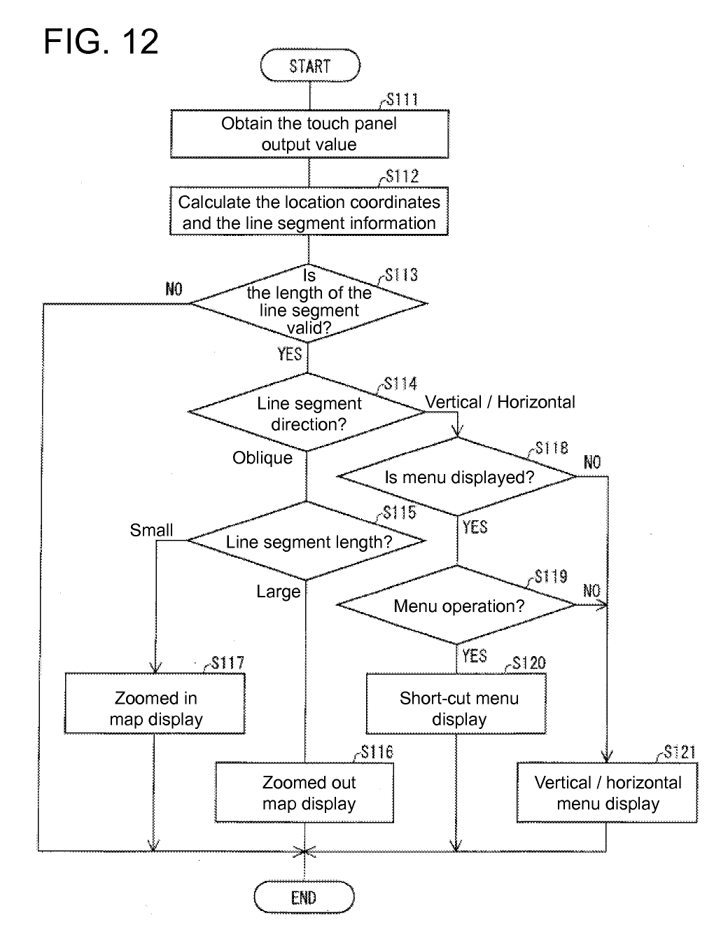

### DETAILED DESCRIPTION OF EMBODIMENTS

An embodiment of the present invention is described in detail below. However, the scope of the present invention is not limited to the descriptions. Embodiments other than described below as an example can also be appropriately modified within the spirit of the present invention. Specifically, the present invention is not limited to embodiments described below. Various changes can be made within the scope of the appended claims. That is, embodiments obtained by combining technological means modified within the scope of appended claims are also included in the technological scope of the present invention.

### Configuration of a Display Device Equipped with a Touch Panel According to the Present Invention

A display device equipped with a touch panel according to the present invention includes a touch panel that receives a touch operation by a plurality of fingers of a user and outputs information on the nature of the touch operation, and a display panel that displays images based on the above-mentioned information. The touch panel includes a touch input section, a finger location detecting section, a fingertip orientation detecting section, and an information output section. The touch input section receives a touch operation performed by fingers of a user, the finger location detecting section detects the position of the fingers used to perform the touch operation, the fingertip orientation detecting section detects the fingertip orientations of the fingers used to perform the touch operation, and the information output section outputs information on the position of the finger detected by the finger location detecting section and on the fingertip orientation detected by the fingertip orientation detecting section.

In the present invention, no particular finger is specified as any of the plurality of fingers. For example, when two fingers are used, the two fingers may be neighboring fingers of one hand, such as the index finger and the middle finger, or the middle finger and the ring finger. Alternatively, two non-neighboring fingers of one hand, such as the index finger and the ring finger, or the index finger and the little finger, may be used. Further, one finger from one hand and another finger from the other hand, such as a right index finger and a left index finger, or a right index finger and a left middle finger, may also be used. However, to obtain equal fingertip orientations from two fingers, preferably two fingers of one hand are used for the touch operation. The statement above about the use of two fingers also applies to the use of three or more fingers.

In a display device equipped with a touch panel according to the present invention, preferably the information output section outputs the above-mentioned information when the fingertip orientations of the fingers used to perform the touch operation are identical.

In the present invention, when fingertip orientations are identical, it does not mean that the fingertip orientations of the plurality of fingers are exactly the same, but means that angles of the lines extending straight from the respective plurality of fingers are within a range considered identical for the content of the process.

In a display device equipped with a touch panel according to the present invention, preferably, the information output section outputs the above-mentioned information when the shortest distance of the distances between the plurality of fingers used to perform the touch operation is at least equal to the shorter radius, longer radius, or the radius of the smallest contact surface formed between the touch panel and a finger of the plurality of fingers used to perform the touch operation, and is no greater than the shorter radius, the longer radius, or the radius of the largest contact surface formed between the touch panel and a finger of the plurality of fingers used to perform the touch operation.

Here, the above-mentioned shortest distance is determined in the following manner. When the contact surface formed between the finger and the touch panel is observed with the fingertips on the top side, if the contact surface forms a vertically long oval shape, the shortest distance is evaluated by referring to the shorter radius and the shorter diameter. If the contact surface forms a horizontally long oval shape, the shortest distance is evaluated by referring to the longer radius and the longer diameter. If the contract surface is a circle, the shortest distance is evaluated by referring to the radius and the diameter of the circle.

In the present invention, the shortest distance of the distances between the plurality of fingers means the distance between any most closely located two points of points each representing the location of one of the plurality of fingers.

### Function Block Diagram Showing Functions of a Display Device Equipped with a Touch Panel According to the Present Invention

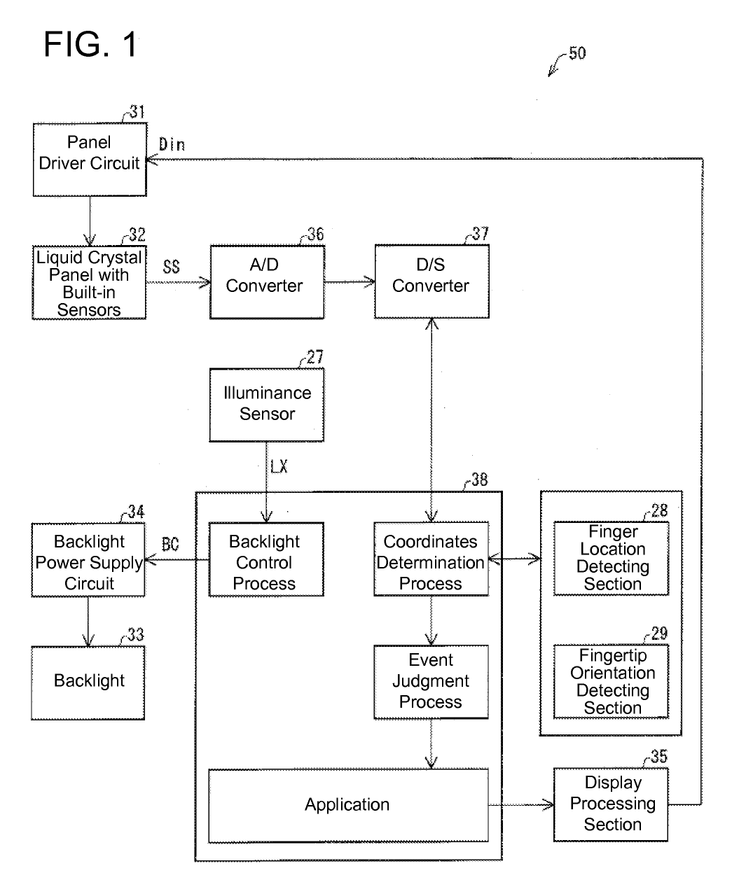

FIG. 1 is a function block diagram of a display device equipped with a touch panel 50 according to the present invention. The display device equipped with a touch panel 50 shown in FIG. 1 includes, as main components, a panel driver circuit 31, a liquid crystal panel with built-in sensors 32, a backlight 33, a backlight power supply circuit 34, an A/D converter 36, an illuminance sensor 27, and a microprocessor unit (hereinafter referred to as MPU) 38.

Here, the panel driver circuit 31, the liquid crystal panel with built-in sensors 32, the backlight 33, the backlight power supply circuit 34, the A/D converter 36, and the illuminance sensor 27 are included in the display panel of the display device equipped with a touch panel 50. On the other hand, the MPU 38 may be included as an external device, separate from the display panel or the touch panel, or may be built in the display panel.

The liquid crystal panel with built-in sensors 32 (hereinafter also referred to as “liquid crystal panel 32”) includes a plurality of pixel circuits and a plurality of optical sensors, which are arranged two-dimensionally. The liquid crystal panel 32 is described in detail below.

To the display panel, a display data Din, which is outputted from the display processing section 35, is inputted. The inputted display data Din is supplied to the panel driver circuit 31. The panel driver circuit 31 writes a voltage corresponding to the display data Din to the pixel circuit of the liquid crystal panel 32. Thus, on the liquid crystal panel 32, an image based on the display data Din is displayed by the pixels.

The backlight 33 includes a plurality of LEDs (Light Emitting Diode), and projects the light (light from the backlight) to the back surface (the surface on the side opposite from the user) of the liquid crystal panel 32. The backlight power supply circuit 34 switches between sending and not sending the power supply voltage to the backlight 33 in accordance with the backlight control signal BC outputted from MPU 38, which is based on the ambient environmental illumination level LX of the output from of the illuminance sensor 27. Hereinafter, it is assumed that the backlight power supply circuit 34 supplies the power supply voltage when the backlight control signal BC is at a high level, and does not supply the power supply voltage when the backlight control signal BC is at a low level. The backlight 33 turns ON when the backlight control signal BC is at the high level, and turns OFF when the backlight control signal BC is at the low level.

The liquid crystal panel 32 outputs the output signal of the optical sensor as a sensor output signal SS. The A/D converter 36 converts the sensor output signal SS, which is analog, to a digital signal. The output signal of the A/D converter 36 represents the information received by the touch input section (not shown) of the touch panel. Then, the D/S converter 37 converts this digital signal to a scan image as necessary.

Based on the sensor output signal SS (digital signal), MPU 38 performs a process for identifying the finger location and the fingertip orientation of a touch from the information detected by the finger location detecting section 28 and the fingertip orientation detecting section 29 of the touch panel and outputted by the information output section (not shown), and determines the coordinates (location) and the direction of the touch. Specifically, based on the sensor output signal SS (digital signal) from the liquid crystal panel 32 and/or the scan image, MPU 38 calculates whether any coordinates are touched (pressed), and further, if any coordinates are determined to be touched (pressed), calculates the fingertip orientation of the finger that is touching (pressing). Then, MPU 38 outputs data such as coordinates. Next, MPU 38 conducts an event judgment process based on the outputted coordinates data. Specifically, based on the coordinates data outputted after the coordinates determination process, MPU 38 determines whether the touch was a multi-touch (multi-point pressing), a single touch (one point pressing), a coordinates process, or a gesture for drawing a straight line, a circle, or the like. After that, based on the event judgment, MPU 38 runs an application. Specifically, based on the event judgment, MPU 38 runs a program that performs input and output, and calculation.

After that, based on the information outputted from the program that was run, the display processing section (information output section) 35 conducts a display process. Then, based on the information processed by the display process, the display processing section 35 outputs the display data Din to the panel driver circuit 31 in the display panel.

In the present invention, no gesture (operation involving finger movements) is necessary to shift the displayed image. However, gestures are not intended to be prohibited. Cases in which gestures are used to shift displayed images may be within the scope of the present invention.

### Method for Controlling a Display Device Equipped with a Touch Panel of the Present Invention

A method for controlling a display device equipped with a touch panel of the present invention includes: a touch input step of receiving a touch operation performed by a plurality of fingers of a user; a finger location detection step of detecting the locations of the fingers used to perform the touch operation; a fingertip orientation detection step of detecting the fingertip orientation of the fingers used to perform the touch operation; an information output step of outputting information on the locations of the fingers detected in the finger location detection step and on the fingertip orientation detected in the fingertip orientation detection step; and an image display step of displaying an image based on the information outputted in the information output step.

Preferably, a method for controlling the display device equipped with a touch panel of the present invention further includes a fingerprint detection step of generating a detection signal in accordance with the fingerprints (especially the fingerprint pattern) of the fingers used to perform the touch operation.

Specifically, a method for controlling the display device equipped with a touch panel of the present invention is controlled as shown in the function block diagram of the display device equipped with a touch panel 50 shown in FIG. 1. Here, the touch input step is controlled by the touch input section, and the finger location detection step is controlled by the finger location detecting section (finger location detecting section 28), the fingertip orientation detection step is controlled by the fingertip orientation detecting section (fingertip orientation detecting section 29), the information output step is controlled by the information output section, and the image display step is performed by the display panel (the panel driver circuit 31 and the liquid crystal panel with built-in sensors 32). The fingerprint detection step is controlled by the fingerprint detecting section.

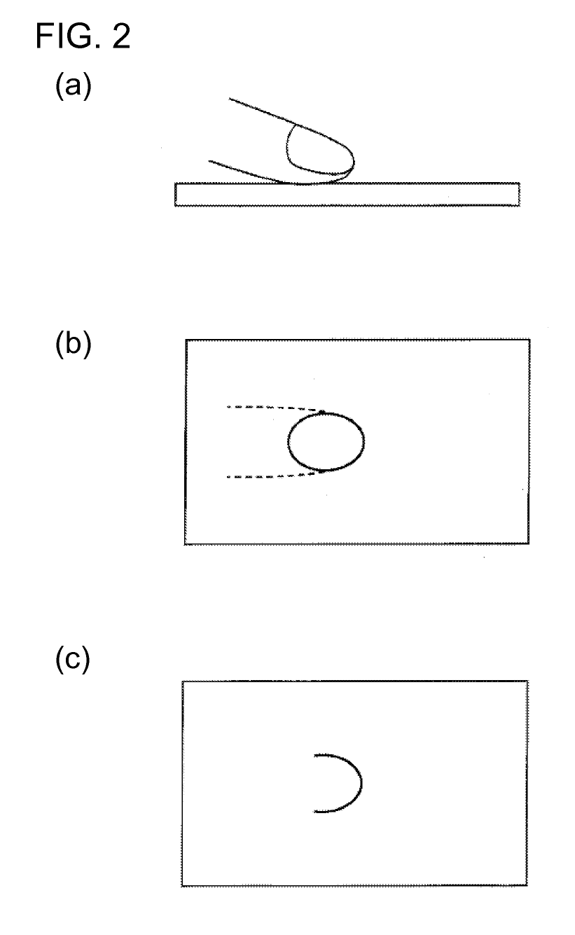

In a display device equipped with a touch panel of the present invention, the fingertip orientation detecting section detects the fingertip orientation according to the edge strength of the sensor image obtained, for example. This is described in detail with reference to FIG. 2(a) to FIG. 2(c).

FIG. 2(a) is a side view showing a touch panel of the present invention when a touch operation by a user finger is received. FIG. 2(b) is a plan view of the touch panel of the present invention, showing a sensor image when a touch operation performed by a user finger is received. FIG. 2(c) is a plan view of the touch panel of the present invention, showing an edge extraction image when a touch operation by a user finger is received.

When the touch operation by a user finger is received, the sensor output signal SS indicates that the edge becomes stronger at the fingertip, and becomes weaker towards the root of the finger. Therefore, fingertip orientation can be detected by identifying the side with a stronger edge.

Preferably, the display device equipped with a touch panel of the present invention also includes a fingerprint detecting section that, besides detecting the orientation of the fingertip as described above, generates a detection signal in accordance with the fingerprint (especially the fingerprint pattern) of the finger used to perform the touch operation. Also, preferably, the fingertip orientation detecting section recognizes the fingerprint based on the detection signal, and detects the fingertip orientation based on the recognized fingerprint.

The fingerprint detecting section may generate a detection signal by detecting recesses and protrusions of the fingerprint. The recesses and protrusions may be detected by a relatively simple system, such as the electrostatic capacitance system. Also, the fingerprint detecting section may generate the detection signal by detecting the curving shape of the fingerprint. This is because most fingerprints have a U-shaped pattern having an opening facing the root of the finger.

Preferably, a display device equipped with a touch panel of the present invention shifts the image displayed on the display panel to the direction opposite from the fingertip orientation.

Here, the direction opposite from the fingertip orientation means the direction opposite from the fingertip orientation of one finger, or the direction opposite from the fingertip orientation of any one of the plurality of fingers.

### Touch Panel of a Display Device Equipped with a Touch Panel of the Present Invention

The touch panel of a display device equipped with a touch panel of the present invention includes: a touch input section, a finger location detecting section, a fingertip orientation detecting section, and an information output section. The touch input section receives a touch operation performed by a plurality of fingers of a user. The finger location detecting section detects the locations of the fingers used to perform the touch operation. The fingertip orientation detecting section detects the fingertip orientation of the fingers used to perform the touch operation. The information output section outputs information on the locations of fingers detected by the finger location detecting section and on the fingertip orientation detected by the fingertip orientation detecting section.

Here, the touch panel in the present invention refers to a touch panel type input device (location input device such as a touch pad). Specifically, it refers to an input device that let users operate an instrument (display device) by touching or approaching the items displayed on the screen. The touch panel according to the present invention is also called touch screen, touch display, or the like.

The touch panel in a display device equipped with a touch panel of the present invention includes the configuration and functions of touch panels known to the public, in addition to the configuration and functions mentioned in the description of the function block diagram.

### Display Panel in a Display Device Equipped with a Touch Panel of the Present Invention

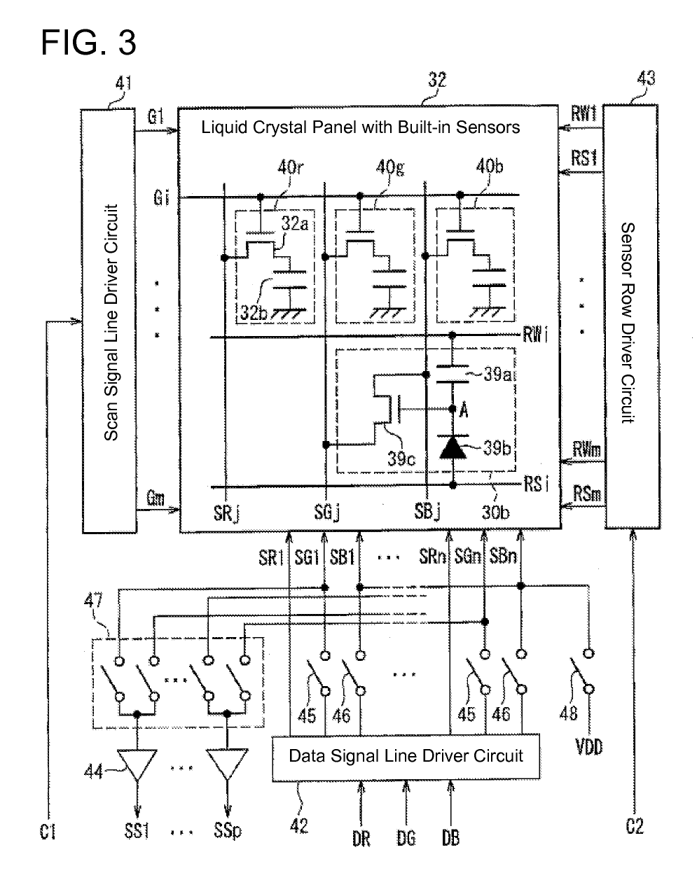

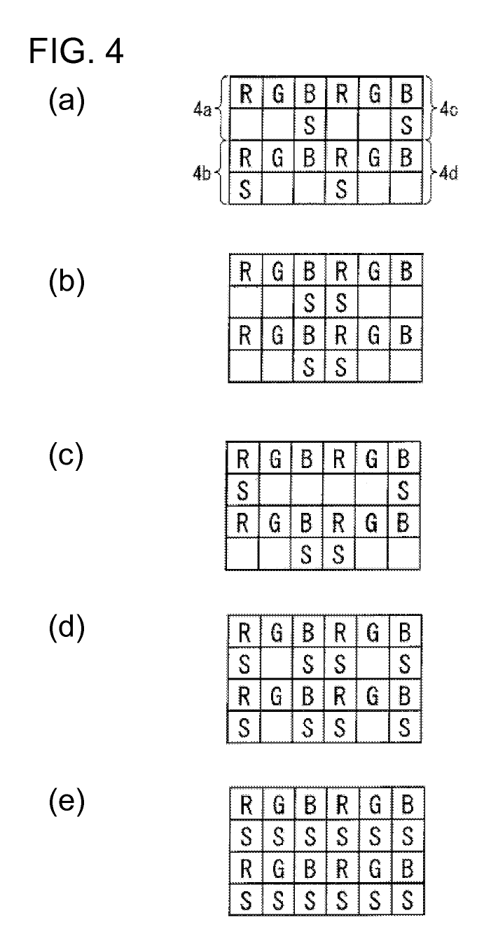

FIG. 3 is a circuit block diagram showing the circuit configuration of the liquid crystal panel 32 in the present invention and the configuration of its peripheral circuits. FIG. 4 shows an example case in which the RGB color filters are arranged in stripes, where an optical sensor 30b is disposed such that a photodiode 39b is located in the same column as a blue picture element 40b, i.e., the photodiode 39b is located on the back surface of the blue filter. The color filters may be arranged in shapes other than stripes, such as mosaic shapes or delta shapes.

In other pixels, which are not shown in FIG. 3, an optical sensor 30r is disposed such that a photodiode 39r is located on the back surface of the red filter which is shared with a red picture element 40r. The number of the optical sensors 30b of the blue picture element 40b and the number of the optical sensors 30r of the red picture element 40r are about the same, and they are both arranged in a regular pattern.

FIG. 4(a) schematically shows an example of the arrangement of optical sensors 30 in this case. In this figure, “R”, “G”, and “B” denote the red picture element, green picture element, and blue picture element, respectively. “S” denotes an optical sensor. In pixels 4a and 4c, the optical sensor “S” is disposed with the blue picture element “B”, and in pixels 4b and 4d, the optical sensor “S” is disposed with the red picture element 4b.

In FIG. 4(a), for every horizontal line, the optical sensors “S” are arranged with a picture element that is different from the previous horizontal line. However, the arrangement rule is not limited to such. For example, as shown in FIG. 4(b), optical sensors “S” may be arranged with a different picture element for every vertical line. Also, as shown in FIG. 4(c), optical sensors “S” may be arranged with a different picture element for every adjacent pixel. Further, as shown in FIG. 4(d) or FIG. 4(e), optical sensors “S” may be disposed with all picture elements.

Here, if the optical sensor “S” is disposed with the green picture element 4g, in FIG. 3, the optical sensor 30g is disposed such that the photodiode 39g is located on the back surface of the green filter shared with the green picture element 40g. Also, the number of the optical sensors 30b of the blue picture element 40b and the number of the optical sensors 30g of the green picture element 40g are about the same, and they are both arranged in a regular pattern.

Described below is an example in which the optical sensor 30b, which is disposed such that the photodiode 39b is located on the back surface of the blue filter in the same column with the blue picture element 40b, outputs the sensor output signal.

As shown in FIG. 3, the liquid crystal panel 32 includes m scan signal lines G1 to Gm; 3 n data signal lines SR1 to SRn, SG1 to SGn, and SB1 to SBn; and (m×3n) pixel circuits 40 (40r, 40g, and 40b). It also includes (m×n) optical sensors 30; m sensor read-out lines RW1 to RWm; and m sensor reset lines RS1 to RSm.

The scan signal lines G1 to Gm are arranged in parallel to each other. The data signal lines SR1 to SRn, SG1 to SGn, and SB1 to SBn are arranged in parallel to each other such that they intersect with the scan signal lines G1 to Gm at a right angle. The sensor read-out lines RW1 to RWm and the sensor reset lines RS1 to RSm are disposed in parallel to the scan signal lines G1 to Gm.

One of the pixel circuits 40 (40r, 40g, and 40b) is disposed near respective one of the intersections of the scan signal lines G1 to Gm and the data signal lines SR1 to SRn, SG1 to SGn, SB1 to SBn. The pixel circuits 40 are, as a whole, arranged two-dimensionally, with m circuits disposed in the column direction (vertical direction in FIGS. 3), and 3 n circuits disposed in the row direction (horizontal direction in FIG. 3).

The pixel circuits 40 can be categorized by the color of the color filter provided: red (R) pixel circuit 40r, green (G) pixel circuit 40g, and blue (B) pixel circuit 40b. The three types of pixel circuits 40r, 40g, and 40b (hereinafter also individually referred to as “picture element (sub-pixel)”) are arranged in the row direction, and three of them jointly form one pixel.

The pixel circuit 40 includes a TFT (Thin Film Transistor) 32a and a liquid crystal capacitance 32b. The gate terminal of TFT 32a is connected to the scan signal line Gi (i is an integer of at least 1 and no greater than m), the source terminal is connected to one of the data signal lines SRj, SGj, and SBj (j is an integer of at least 1 and no greater than n), and the drain terminal is connected to one of the electrodes of the liquid crystal capacitance 32b. The common electrode voltage is applied to the other electrode of the liquid crystal capacitance 32b. Hereinafter, data signal lines SG1 to SGn connected to the green (G) pixel circuit 40g are called G data signal lines, and data signal lines SB1 to SBn connected to the blue (B) pixel circuit 40b are called B data signal lines. The pixel circuit 40 may include an auxiliary capacitance.

The transmittance (luminance of the picture element) of the pixel circuit 40 is determined by the voltage written to the pixel circuit 40. To write a voltage to the pixel circuit 40 connected to the scan signal line Gi and to the data signal line SXj (X is R, G, or B), a high level voltage (voltage that turns TFT 32a ON) can be applied to the scan signal line Gi, and a voltage to be written can be applied to the data signal line SXj. The luminance of the picture element can be set to a desired level by writing a voltage corresponding to the display data Din to the pixel circuit 40.

The optical sensor 30 includes a capacitor 39a, a photodiode 39b, and a sensor preamplifier 39c, and is disposed at least for each blue picture element 40b (blue (B) pixel circuit 40b).

One electrode of the capacitor 39a is connected to the cathode terminal of the photodiode 39b (hereinafter, this connecting point is referred to as “contact A”). The other electrode of the capacitor 39a is connected to the sensor read-out line RWi, and the anode terminal of the photodiode 39b is connected to the sensor reset line RSi. The sensor preamplifier 39c is constituted of a TFT whose gate terminal is connected to contact A, the drain terminal is connected to B data signal line SBj, and the source terminal is connected to G data signal line SGj.

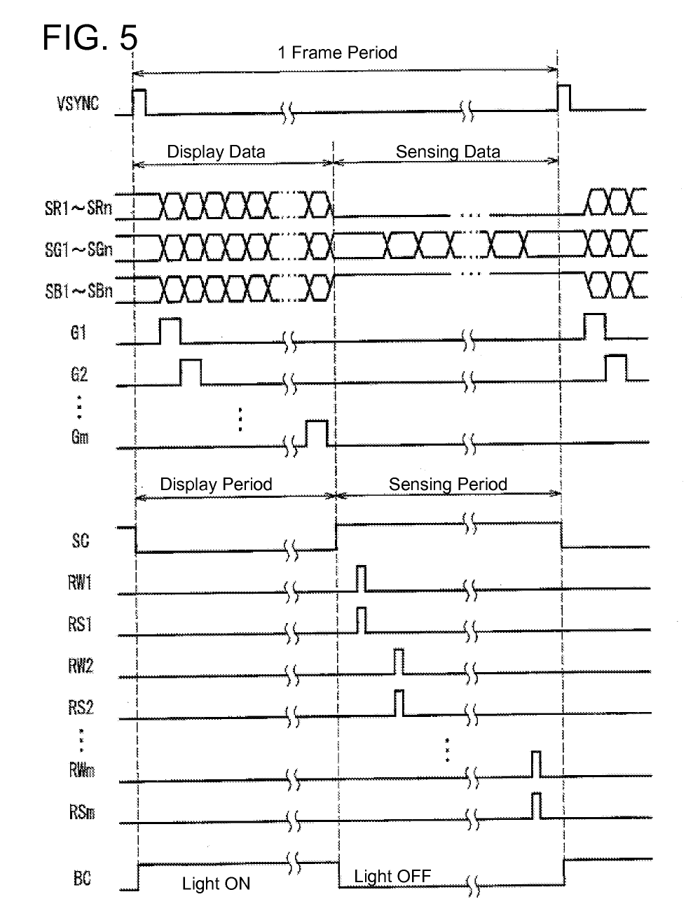

To detect the light amount at the optical sensor 30 connected to the sensor read-out line RWi, the B data signal line SBj, and the like, a prescribed voltage can be applied to the sensor read-out line RWi and to the sensor reset line RSi, and a power supply voltage VDD can be applied to the B data signal line SBj at the timings shown in the timing chart of FIG. 5. After the prescribed voltage is applied to the sensor read-out line RWi and to the sensor reset line RSi, when light enters the photodiode 39b, the current corresponding to the amount of the light entered flows to the photodiode 39b, and the voltage at contact A decreases according to the current that flowed. When the power supply voltage VDD is applied to the B data signal line SBj, the voltage at contact A is amplified by the sensor preamplifier 39c, and the amplified voltage is outputted to the G data signal line SGj. Therefore, based on the voltage at the G data signal line SGj, the amount of light detected by the optical sensor 30 can be obtained.

In the periphery of the liquid crystal panel 32, a scan signal line driver circuit 41, a data signal line driver circuit 42, a sensor row driver circuit 43, p (p is an integer of at least 1 and no greater than n) sensor output amplifiers 44, and a plurality of switches 45 to 48 are provided. The scan signal line driver circuit 41, the data signal line driver circuit 42, and the sensor row driver circuit 43 are equivalent to the panel driver circuit 31 in FIG. 1.

The data signal line driver circuit 42 has 3 n output terminals corresponding to 3 n data signal lines. One switch 45 is provided between each of G data signal lines SG1 to SGn and the corresponding one of n output terminals, and one switch 46 is provided between each of B data signal lines SB1 to SBn and the corresponding one of n output terminals. G data signal lines SG1 to SGn are divided into groups of p lines. Within each of the groups, one switch 47 is provided between the kth (k is an integer of at least 1 and no greater than p) G data signal line and the input terminal of the kth sensor output amplifier 44. B data signal lines SB1 to SBn are all connected to one end of the switch 48, and to the other end of the switch 48, the power supply voltage VDD is applied. The number of the switches 45 to 47 included in FIG. 3 is n, and there is only one switch 48.

Circuits shown in FIG. 3 operate differently between during the display period and during the sensing period. During the display period, switches 45 and 46 turn ON, and switches 47 and 48 turn OFF. On the other hand, during the sensing period, switches 45 and 46 turn OFF, switch 48 turns ON, and switch 47 turn ON in a time-division manner such that each groups of G data signal lines SG1 to SGn are connected sequentially to the input terminal of the sensor output amplifier 44.

During the display period shown in FIG. 5, the scan signal line driver circuit 41 and the data signal line driver circuit 42 operate. The scan signal line driver circuit 41 selects one of the scan signal lines G1 to Gm per one line time as instructed by the timing control signal C1, applies a high-level voltage to the selected scan signal line, and applies a low-level voltage to the remaining scan signal lines. The data signal line driver circuit 42 drives the data signal lines SR1 to SRn, SG1 to SGn, and SB1 to SBn in a linear sequential manner based on the display data DR, DG, and DB.

More specifically, the data signal line driver circuit 42 stores the display data DR, DG, and DB at least one line at a time, and for each line time, applies a voltage corresponding to the one line of display data to the data signal lines SR1 to SRn, SG1 to SGn, and SB1 to SBn. The data signal line driver circuit 42 may drive the data signal lines SR1 to SRn, SG1 to SGn, and SB1 to SBn in a dot sequential manner.

During the sensing period shown in FIG. 5, the sensor row driver circuit 43 and the sensor output amplifier 44 operate. The sensor row driver circuit 43 selects one of the sensor read-out lines RW1 to RWm and one of the sensor reset lines RS1 to RSm per one line time as instructed by the timing control signal C2, applies a prescribed read-out voltage and a prescribed reset voltage to the selected sensor read-out line and the selected sensor reset line, respectively, and applies a different voltage to other signal lines. Typically, one line time duration is different between during the display period and during the sensing period. The sensor output amplifier 44 amplifies the voltage selected by the switch 47, and outputs the voltage as the sensor output signals SS1 to SSp.

In FIG. 5, the backlight control signal BC becomes high during the display period, and becomes low during the sensing period. In this case, the backlight 33 turns on during the display period, and turns off during the sensing period. As a result, the influence of the light from the backlight on the photodiode 39b can be reduced.

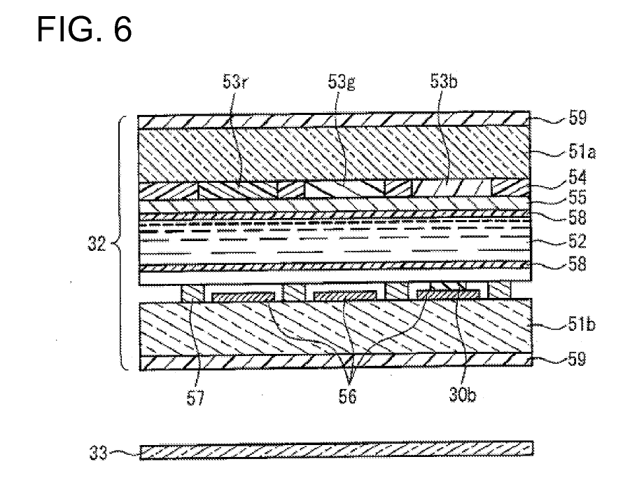

FIG. 6 is a cross-sectional view showing an example of the configuration of the liquid crystal panel 32 of the present invention. The liquid crystal panel 32 has a configuration in which, for example, a liquid crystal layer 52 is sandwiched between two glass substrates 51a and 51b. On one of the glass substrates, i.e., a glass substrate 51a, three color filters 53r, 53g, and 53b, light-shielding films 54, an opposite electrode 55, and the like, for example, are provided. On the other glass substrate, i.e., the glass substrate 51b, pixel electrodes 56, data signal lines 57, an optical sensor 30, and the like, for example, are provided.

The optical sensor 30 is disposed near the pixel electrode 56 with, for example, the blue color filter 53b. In this case, preferably, at least the photodiode 39b of the optical sensor 30 is disposed at the center of the color filter 53 on the back surface so that the light transmitted by the color filter 53 is reliably received by the photodiode 39b.

On each of the surfaces of the glass substrates 51a and 51b, which surfaces are facing each other, an alignment film 58 is provided, and on each of the other surfaces, a polarizing plate 59 is provided. Of the two surfaces of the liquid crystal panel 32, the surface on the side of the glass substrate 51a is the front surface, and the surface on the side of the glass substrate 51b is the back surface. The backlight 33 is disposed facing the back surface of the liquid crystal panel 32.

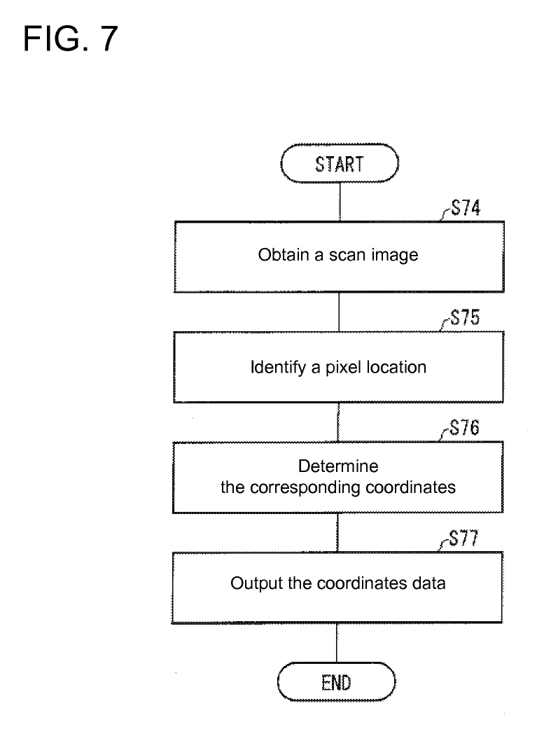

FIG. 7 is a flowchart showing an example of the process performed by the display device equipped with a touch panel 50 of the present invention, for identifying the location of a touch. The process shown in FIG. 7 is performed by MPU 38 shown in FIG. 1 within one frame period.

The A/D converter 36 (see FIG. 1) converts the analog output signal SS outputted by the optical sensor 30 included in the liquid crystal panel 32 to a digital signal.

MPU 38 obtains this digital signal as a scan image (step S74). Further, the MPU 38 performs a process on the scan image obtained for identifying a pixel location (step S75).

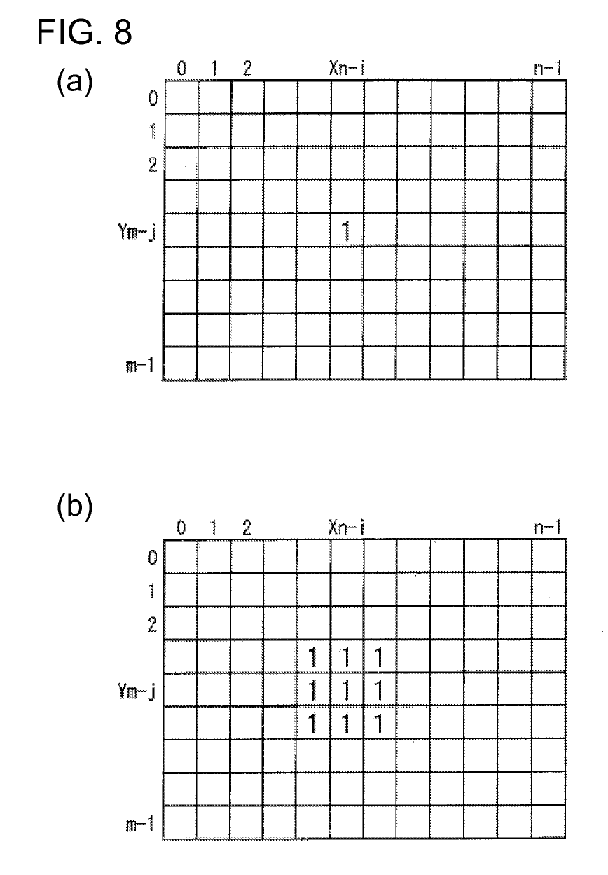

For example, FIG. 8(a) schematically shows a scan image having m×n pixels. As shown in FIG. 8(a), if the scan image is binarized based on a prescribed threshold, a pixel with a value of “1” is determined as a pixel touched, and the pixel location of this pixel is identified. FIG. 8(a) shows the identified location of a pixel (Xn-i, Ym-j).

On the other hand, FIG. 8(b) shows a scan image when a plurality of pixels are touched. Pixel locations identified in this case include eight pixels adjacent to the pixel location (Xn-i, Ym-j). The scan image shown in FIG. 8(b) is obtained when the arrangement rule shown in FIG. 4(d) or FIG. 4(e) is used.

Once the pixel location is identified, MPU 38 conducts a process that determines the coordinates (location) within the image corresponding to the identified pixel (step S76). For example, as shown in FIG. 8(a), the coordinates corresponding to the identified pixel location (Xn-i, Ym-j) are determined. If the image resolution of the displayed image and the display resolution of the liquid crystal panel match and they are both “m×n”, the pixel location (Xn-i, Ym-j) is determined as the coordinates (location). If the image resolution and the display resolution do not match, the coordinate conversion can be conducted to determine the coordinates (location) corresponding to the pixel location.

As shown in FIG. 8(b), if the eight pixel locations including the pixel location (Xn-i, Ym-j) are identified, the coordinates (location) can be determined based on a prescribed rule. For example, the coordinates (location) can be determined based on the pixel closest to the weighted center of the identified pixels. In this case, as shown in FIG. 8(b), of the plurality of pixels with the value of “1”, the pixel location corresponding to the weighted center (Xn-i, Ym-j) can be determined. Alternatively, in FIG. 8(b), the coordinates that corresponds to all pixel locations with the value of “1” may be determined as the coordinates (location).

Once the coordinates (location) are determined, MPU 38 outputs the coordinates data at the determined coordinates to the panel driver circuit 31 in the display panel (step S77).

In the display device equipped with a touch panel 50 of the present invention, the process in which the orientation of the touching fingertip is identified is conducted as follows. This process is conducted by MPU 38 shown in FIG. 1.

The A/D converter 36 (see FIG. 1) converts the analog output signal SS outputted from the optical sensor 30 included in the liquid crystal panel 32 to a digital signal. Then, MPU 38 obtains this digital signal as the sensor image.

Here, when a touch operation performed by user fingers is received, the sensor output signal SS indicates that the edge becomes stronger at the fingertip, and becomes weaker towards the root of the finger. Therefore, fingertip orientation can be detected by identifying the side with stronger edge.

Thus, from the sensor image obtained, MPU 38 can conduct a process for identifying the edge extraction image.

When the edge extraction image is identified, MPU 38 conducts a process for determining the shifting direction for the identified edge extraction image. When the shifting direction is determined, MPU 38 outputs the data present towards the determined shifting direction to the panel driver circuit 31 in the display panel.

Data on the finger locations and the fingertip orientation are sent to a camera, a music player, and the like. Then, processes according to the operation of the application software such as those shown below are conducted.

### Method for Operating the Display Device Equipped with a Touch Panel of the Present Invention and Displayed Images

The display device equipped with a touch panel of the present invention is operated by touching the touch panel with a finger, a pen, and the like. By the touch operation, on the display device equipped with a touch panel, an activity such as a change in the image or a change in the audio volume occurs.

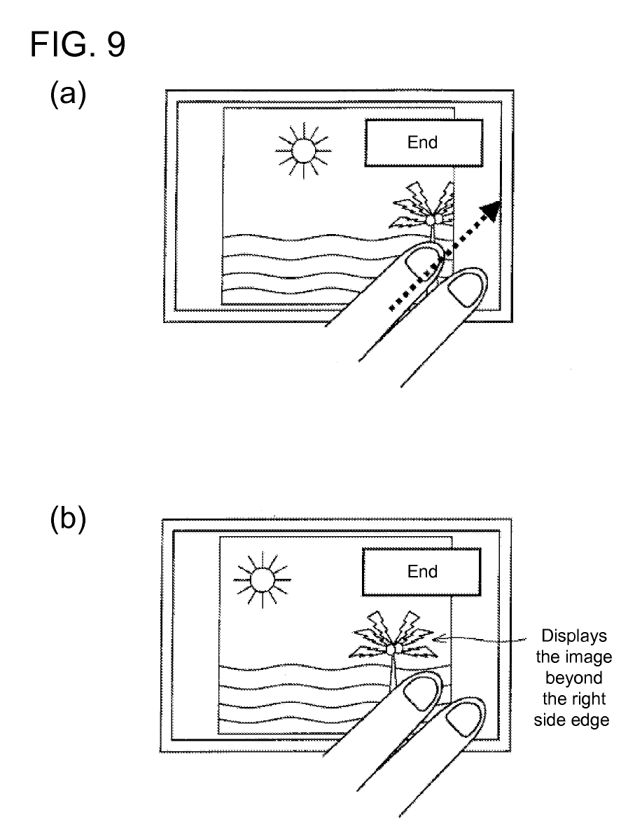

FIG. 9(a) is an image displayed on the display device equipped with a touch panel of the present invention before the touch, and FIG. 9(b) is an image displayed on the display device equipped with a touch panel of the present invention after the touch.

As shown in FIG. 9(a) and FIG. 9(b), when coordinates of two fingers used to perform the touch operation are close to each other, and the fingertip orientations are identical, coordinates including the fingertip orientations of the two fingers used to perform the touch operation are passed from the coordinates determination process to the event judgment process, and the coordinate system parameter is passed to the application (see FIG. 1). In FIG. 9(a) and FIG. 9(b), a case in which a touch operation is performed by two fingers is shown as an example. However, the present invention is not limited to this.

In the application, if the coordinates detection at the second point was conducted within a predetermined time period after the coordinates detection at the first point, if the coordinates of the first point and the coordinates of the second points are close to each other, and if the fingertip orientation at the first point and the fingertip orientation of the second point are identical, a process involving parameter increase/decrease is conducted. The parameter increase/decrease operation can be controlled by an application. This is described using examples such as (A) and (B) below.

(A) Camera
(1) If the fingertip orientation is rightward, the image beyond the right side edge is shown (the displayed image pans to right and shifts to left, as shown in FIG. 9(a) and FIG. 9(b)).
(2) If the fingertip orientation is leftward, the image beyond the left side edge is displayed (the displayed image pans to left, and shifts to right).

FIG. 9(a) and FIG. 9(b) are based on the assumption of camera panning, and therefore the displayed image shifts only to the right or to the left. However, the image can be shifted up/down using a viewer or the like.

(B) Music Player
(1) If the fingertip orientation is rightward, the audio volume increases.
(2) If the fingertip orientation is leftward, the audio volume decreases.

The audio volume is adjusted by notifying the application at MPU 38 of the fingertip angle. Based on the notified fingertip angle data, the application determines the movement.

(C) Mobile Terminal Menu Display
(1) If the fingertip orientation is upward, characters are displayed in the normal direction.
(2) If the fingertip orientation is downward, characters are displayed in the opposite direction.

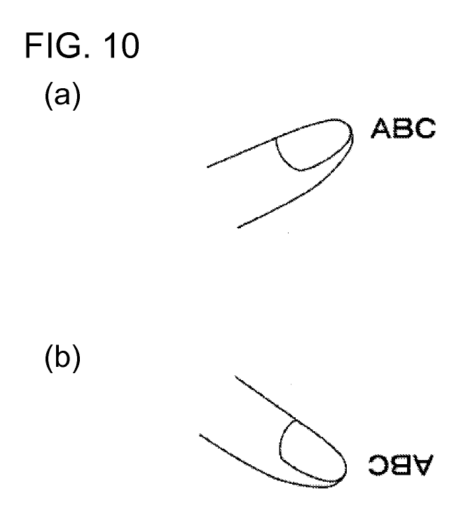

FIG. 10(a) shows a finger and characters displayed when the fingertip orientation is upward. FIG. 10(b) shows a finger and characters displayed when the fingertip orientation is downward.

(D) Navigation Map Display

A point in the map indicated by the fingertip orientation with an absolute angle is scrolled to the center.

As shown in FIG. 9(a), FIG. 9(b), FIG. 10(a), and FIG. 10(b), according to display devices equipped with a touch panel of the present invention, a user can operate the device without moving his/her finger.

### Example of Realization of a Display Device Equipped with a Touch Panel of the Present Invention Using a Program

Each block (configuration) of a display device equipped with a touch panel of the present invention may be configured with a hardware logic, or may be realized with software using a CPU as described below.

That is, a display device equipped with a touch panel of the present invention includes: a CPU (central processing unit) that executes the instructions of a control program for realizing individual functions; a ROM (read only memory) that stores the program; a RAM (random access memory) that decompresses the program; and a storage device (recording medium) such as a memory that stores the program and various data. The objectives of the present invention can also be realized by providing the above-mentioned display device equipped with a touch panel with a recording medium that stores the program code (executable program, intermediate code program, source program) of the control program, i.e., a software for realizing the above-mentioned functions, in a format readable by a computer, and by having the computer (or CPU or MPU) retrieve the program codes stored in the recording medium and execute them.

The recording medium can be, for example, a tape such as a magnetic tape or a cassette tape; a disk including a magnetic disk such as a floppy (registered trademark) disk or a hard disk, an optical disk such as a CD-ROM, MO, MD, DVD, or CD-R; a card such as an IC card (including a memory card) or optical card; or a semiconductor memory such as a mask ROM, EPROM, EEPROM, or flash ROM.

The display device equipped with a touch panel may be configured to be connectable to a communication network, and the above-mentioned program code may be supplied via the communication network. The communication network is not particularly limited. As the communication network, the internet, intranet, extranet, LAN, ISDN, VAN, CATV communication net, virtual private network, telephone network, mobile communication network, satellite communication network, and the like, for example, can be used. Also, the transmission medium constituting the communication network is not particularly limited. As the transmission medium constituting the communication network, wires such as IEEE1394, USB, power line carrier, cable TV network, telephone line, ADSL network, or radio such as infrared (ex. IrDA or remote control), Bluetooth (registered trademark), 802.11 radio, HDR, mobile telephone network, satellite network, digital terrestrial network, for example, can be used. The present invention can also be realized using computer data signals embedded in a carrier wave, in which the above-mentioned program code is presented in the form of electronic transmission.

### Preferred Embodiments of the Present Invention

Preferably, in a display device equipped with a touch panel of the present invention, the information output section outputs the information when orientations of a plurality of fingers used to perform the touch operation are identical.

This makes it easier for the display device equipped with a touch panel of the present invention to determine the direction of the operation, and therefore the display device can be operated even more easily and more accurately.

In a display device equipped with a touch panel of the present invention, preferably, the information output section outputs the above-mentioned information when the shortest distance of the distances between the plurality of fingers used to perform the touch operation is at least equal to the shorter radius, longer radius, or the radius of the smallest contact surface formed between the touch panel and a finger of the plurality of fingers used to perform the touch operation, and is no greater than the shorter radius, the longer radius, or the radius of the largest contact surface formed between the touch panel and a finger of the plurality of fingers used to perform the touch operation.

This way, operation error does not occur in the display device equipped with a touch panel of the present invention as a result of an unintended touch in a multiple-point touch operation. Consequently, the display device equipped with a touch panel of the present invention can be operated with higher accuracy.

Preferably, the display device equipped with a touch panel of the present invention further includes a fingerprint detecting section that generates a detection signal corresponding to the fingerprint of the finger used in the touch operation, and the fingertip orientation detecting section recognizes the fingerprint based on this detection signal, and detects the fingertip orientation based on the fingerprint recognized.

This way, in the display device equipped with a touch panel of the present invention, it becomes easier to detect the fingertip orientation, and the display device can be operated with even higher accuracy.

Preferably, a display device equipped with a touch panel of the present invention shifts the image displayed on the display panel to the direction opposite from the fingertip orientation.

This way, displayed images shift to a particular direction, and therefore the display device equipped with a touch panel of the present invention can be operated more reliably.

In a method for controlling the display device equipped with a touch panel of the present invention, preferably the information output step outputs the above-mentioned information when the fingertip orientation of the plurality of fingers used to perform the touch operation are identical.

This way, direction of operation is easy to determine, and therefore, in the method for controlling the display device equipped with a touch panel of the present invention, the display device can be controlled even more easily and with higher accuracy.

In the method for controlling the display device equipped with a touch panel of the present invention, preferably, in the information output step, the above-mentioned information is outputted when the shortest distance of the distances between the plurality of fingers used to perform the touch operation is at least equal to the shorter radius, longer radius, or the radius of the smallest contact surface formed between the touch panel and a finger of the plurality of fingers used to perform the touch operation, and is no greater than the shorter radius, the longer radius, or the radius of the largest contact surface formed between the touch panel and a finger of the plurality of fingers used to perform the touch operation.

This way, in the method for controlling the display device equipped with a touch panel of the present invention, operation error is not caused by an unintended touch when multiple points are touched. Consequently, in the method for controlling a display device equipped with a touch panel of the present invention, the display device can be controlled with even higher accuracy.

A method for controlling the display device equipped with a touch panel of the present invention preferably further includes a fingerprint detection step of generating a detection signal corresponding to the fingerprint of the finger used to perform the touch operation. In the fingertip orientation detection step, preferably the fingerprints are recognized based on the detection signal, and the fingertip orientations are detected based on the recognized fingerprint.

This way, in the method for controlling the display device equipped with a touch panel of the present invention, it becomes easier to detect the fingertip orientation, and also the display device can be controlled more accurately.

Preferably, a method for controlling the display device equipped with a touch panel of the present invention shifts a displayed image to the direction opposite to the fingertip orientation.

This way, in the method for controlling the display device equipped with a touch panel of the present invention, display images shift to a particular direction, which provides a more reliable control.

The control program of the present invention operates a display device equipped with a touch panel, and is designed to make a computer operate as individual sections described above. Also, a recording medium of the present invention can be read by a computer storing the control program described above.

Thus, a display device equipped with a touch panel according to the present invention can be realized by a computer.

### Other Embodiments

The specific embodiments described above are merely for illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

A display device equipped with a touch panel of the present invention can also be used for car navigation devices, mobile phones, mobile type information terminals, ATM (automatic teller machine), ticket vending machines, various types of automatic vending machines, game machines, digital audio players, copiers, facsimiles, and the like. Also, the display device equipped with a touch panel of the present invention may be used for electronic blackboards and the like that have functions of the personal computer, television, and display devices.

### DESCRIPTION OF REFERENCE CHARACTERS

27 illuminance sensor

28 finger location detecting section

29 fingertip orientation detecting section

30 optical sensor

31 panel driver circuit

32 liquid crystal panel with built-in sensors

33 backlight

34 backlight power supply circuit

35 display processing section

36 A/D converter

37 D/S converter

38 microprocessor unit (MPU)

41 scan signal line driver circuit

42 data signal line driver circuit

43 sensor row driver circuit

44 sensor output amplifier

45 switch

46 switch

47 switch

48 switch

50 display device equipped with a touch panel

1. A display device equipped with a touch panel, comprising:
a touch panel that receives a touch operation by a plurality of fingers of a user, and outputs information indicating the nature of said touch operation; and
a display panel that displays images based on said information,
wherein said touch panel includes a touch input section, a finger location detecting section, a fingertip orientation detecting section, and an information output section,
wherein said touch input section receives a touch operation performed by a plurality of fingers of a user,
wherein said finger location detecting section detects locations of the fingers used to perform said touch operation,
wherein said fingertip orientation detecting section detects fingertip orientations of the fingers used to perform the touch operation, and
wherein said information output section outputs information on the locations of the fingers detected by said finger location detecting section and on the fingertip orientation detected by the fingertip orientation detecting section.

2. The display device equipped with a touch panel according to claim 1, wherein said information output section outputs said information when the fingertip orientations of the plurality of fingers used to perform said touch operation are identical.

3. The display device equipped with a touch panel according to claim 2, wherein said information output section outputs said information when the shortest distance of the distances between the plurality of fingers used to perform said touch operation is at least equal to a shorter radius, a longer radius, or a radius of the smallest contact surface formed between the touch panel and a finger of the plurality of fingers used to perform said touch operation, and is no greater than a shorter radius, a longer radius, or a radius of the largest contact surface formed between the touch panel and a finger of the plurality of fingers used to perform said touch operation.

4. The display device equipped with a touch panel according to claim 1, further comprising a fingerprint detecting section that generates a detection signal corresponding to fingerprints of the fingers used to perform said touch operation,
wherein said fingertip orientation detecting section recognizes said fingerprints based on the detection signal, and detects the fingertip orientation based on the fingerprint recognized.

5. The display device equipped with a touch panel according to claim 1, wherein an image displayed on said display panel is shifted to a direction opposite from said fingertip orientation.

6. A method for controlling the display device equipped with a touch panel, comprising:
a touch input step of receiving a touch operation performed by a plurality of fingers of a user;
a finger location detection step of detecting the locations of fingers used to perform said touch operation;
a fingertip orientation detection step of detecting fingertip orientations of fingers used to perform said touch operation;
an information output step of outputting information on the finger locations detected in said finger location detection step and on the fingertip orientation detected by said fingertip orientation detection step; and
an image display step of displaying an image based on the information outputted in said information output step.

7. The method for controlling the display device equipped with a touch panel according to claim 6, wherein in said information output step, said information is outputted when the fingertip orientations of fingers used to perform said touch operation are identical.

8. The method for controlling the display device equipped with a touch panel according to claim 7, wherein, in said information output step, said information is outputted when the shortest distance of distances between the plurality of fingers used to perform said touch operation is at least equal to the shorter radius, the longer radius, or the radius of the smallest contact surface formed between the touch panel and a finger of the plurality of fingers used to perform said touch operation, and is no greater than the shorter radius, the longer radius, or the radius of the largest contact surface formed between the touch panel and a finger of the plurality of fingers used to perform the touch operation.

9. The method for controlling the display device equipped with a touch panel according to claim 6, further comprising a fingerprint detection step of generating a detection signal corresponding to fingerprints of fingers used to perform said touch operation,
wherein, in said fingertip orientation detection step, the fingerprints are recognized based on said detection signal, and the fingertip orientation is detected based on said recognized fingerprints.

10. The method for controlling the display device equipped with a touch panel according to claim 6, wherein a displayed image is shifted to a direction opposite to said fingertip orientation.

11. A control program for operating the display device equipped with a touch panel according to claim 1, wherein said control program makes a computer perform functions of said sections.

12. A recording medium that stores the control program according to claim 11, and is readable by a computer.
